(19) United States
(12) Patent Application Publication
(10) Pub. No.: US 2011/0296695 A1
(43) Pub. Date: Dec. 8, 2011

(54) Watermelon Cutter

(76) Inventor: Nazim Temiz, Westlake, OH (US)

(21) Appl. No.: 12/794,326

(22) Filed: Jun. 4, 2010

(51) Int. Cl. A47J 17/00

(52) U.S. Cl. 30/302

(57) ABSTRACT

Cutter for a watermelon processing device. Circular blade separates watermelon from shell, when straight blades cut watermelon into slices. Handles provide easy grip to use device.

### BACKGROUND OF THE INVENTION

1. Field of the Invention

Presented invention relates to watermelon cutter.

2. Prior Art Statement

Watermelon is one of the most indispensable fruit for hot summer days. It is hard to separate slices because of hard, thick and big shell. The prior art, examined from a search conducted at the U.S. Patent and Trademark Office, does not provide a design which solves the mentioned problem in a manner providing the required convenience. Although some of the prior art designs provide watermelon slices. U.S. Pat. No. 2,824,588 to Leander L. Lyon and Florence N. Lyon, melon slicing device incorporates a guided multi-bladed knife assembly, which cuts watermelon into uniform slices. However, this device tend to be larger and does not separates the watermelon from shell.

### SUMMARY OF THE INVENTION

The present invention has circular and straight blades, which are fixed to handle base in order to drive blades simultaneously. After watermelon is cut into two pieces, present invention is placed on watermelon. While holding device with one hand, watermelon can be cut into slices by rotating other handle.

It is an object of the presented invention to provide easy and clean solution to separate watermelon from shell and to cut into eatable size.

### BRIEF DESCRIPTION OF THE DRAWINGS

The present invention will be better understood from following description, and also taken in conjunction with the accompanying drawing in which,

FIG. 1 is a perspective view of the present invention

FIG. 2 is a top view of the present invention

FIG. 3 is a front view of the present invention

FIG. 4 is a right view of the present invention

FIG. 5 is a cross sectional view of straight blade taken along lines A-A in FIG. 2

FIG. 6 is a cross sectional view of circular blade taken along lines B-B in FIG. 3

FIG. 7 is a blow up perspective view of the presented invention

FIG. 8 is a perspective view of the present invention with showing the presented invention in operational position activated by hand of a user shown in phantom.

### DETAILED DESCRIPTION OF THE INVENTION

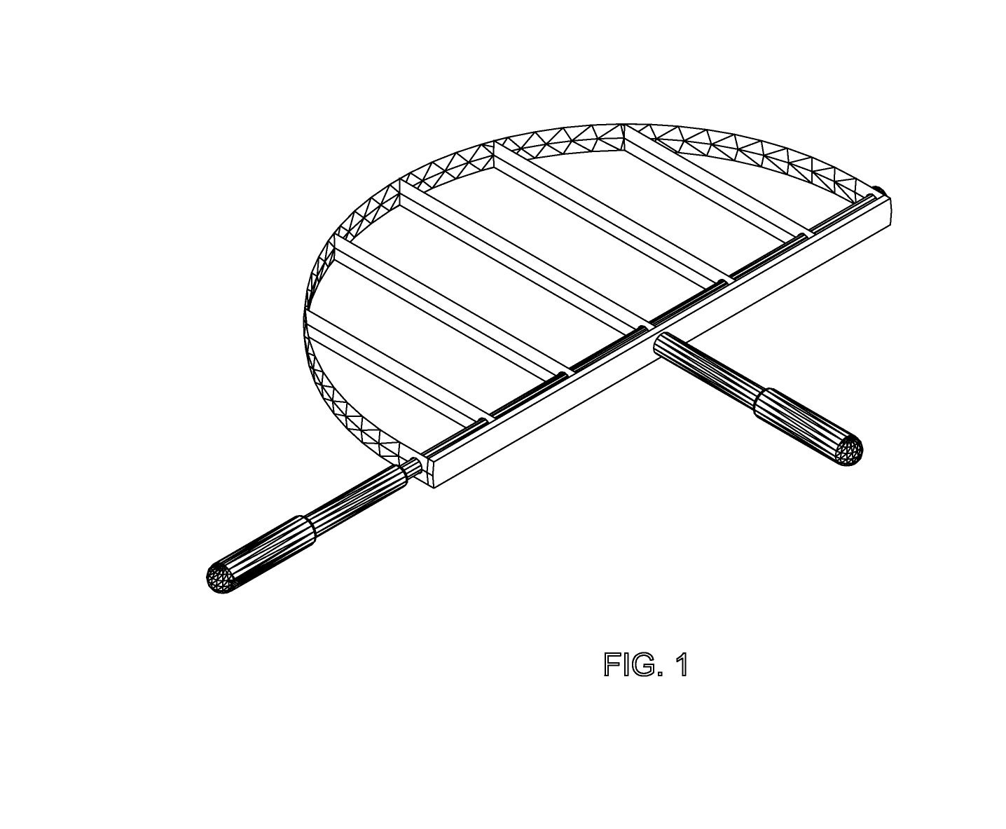

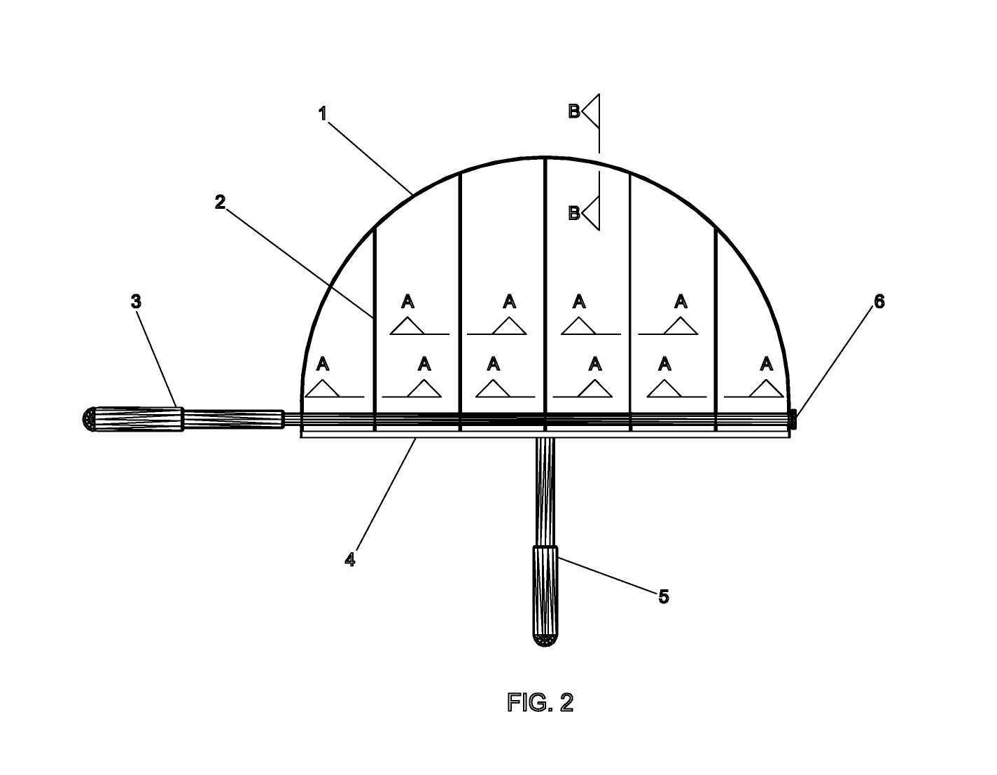

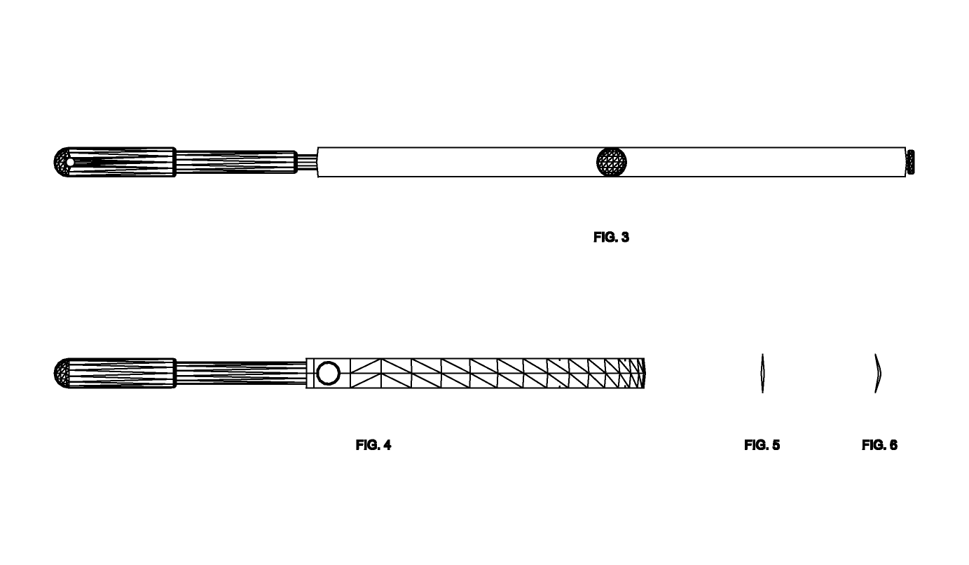

Referring FIG. 1, FIG. 2 and FIG. 7 there is circular blade 1 and straight blades 2 which are attached to secondary handle base 4. Circular blade 1 and straight blades 2 pivoted by axle 3a, which is inserted thru access holes 2a and 3a and connected to fixing nut 6. Primary handle 3 is attached to axle 3a.

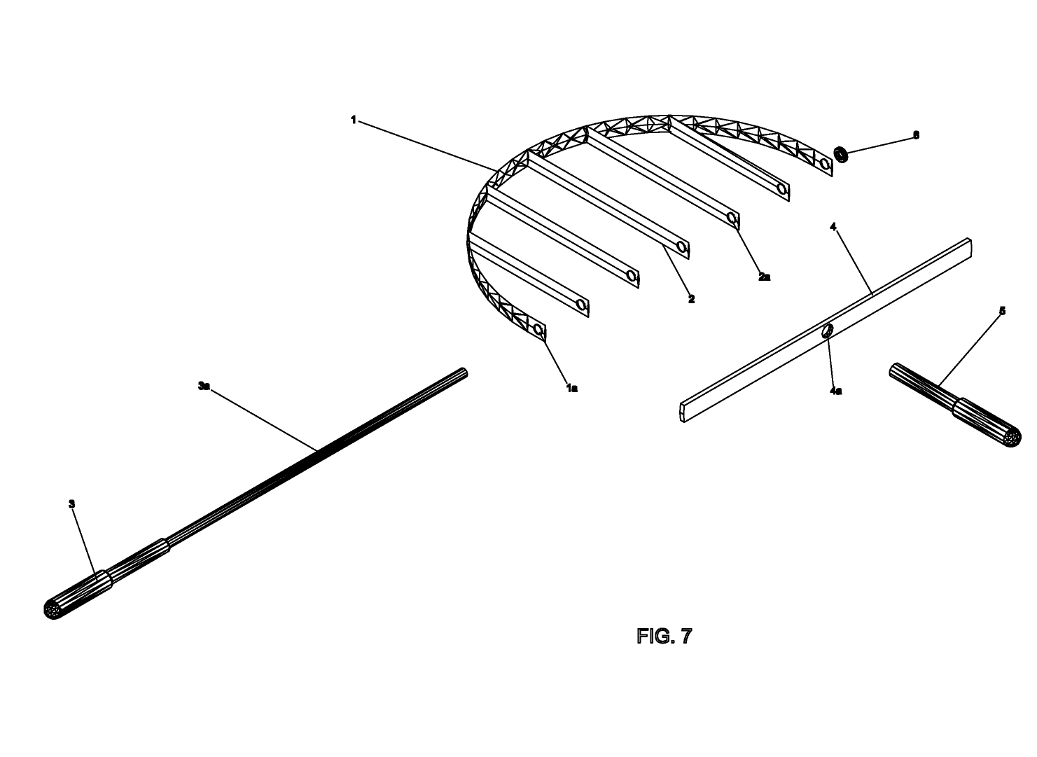

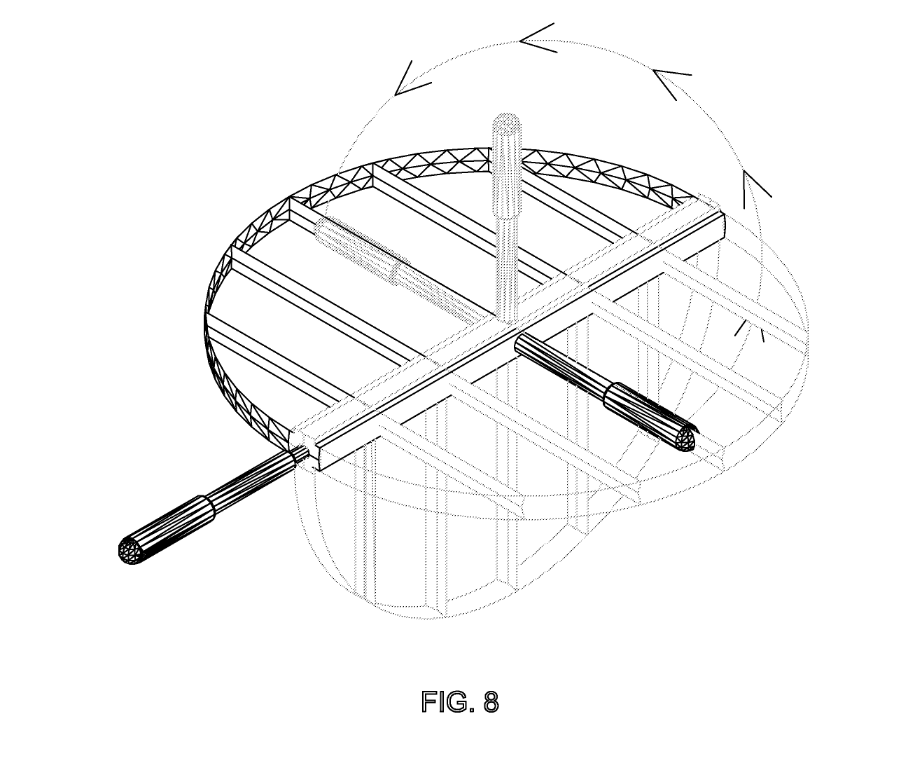

Referring FIG. 8 presented invention can be placed on to watermelon, when user is holding the presented invention from primary handle 3, secondary handle 5 is rotated hundred and eighty degree around axle 3a. After rotating the presented invention ninety degree on watermelon, secondary handle 5 is rotated around axle 3a second time to cut watermelon in to eatable size.

Referring FIGS. 5 and 6 sharp edge of circular blade 1 and straight blades 2 allows to use presented invention each direction. Inside face of circular blade 1 has same radius of circular blades.

What is claimed is:

1. A watermelon cutter comprising circular and straight blades, which are assembled to handle base in rotatable manner by axle. Axle is fixed to primary handle. Secondary handle is fixed to handle base.

2. Watermelon cutter of claim 1, wherein said circular and straight blades have access holes to insert axle.
